(19) United States
(12) Patent Application Publication
(10) Pub. No.: US 2014/0191614 A1
(43) Pub. Date: Jul. 10, 2014

(54) FERROELECTRIC ENERGY CONVERSION USING PHASE CHANGING FLUIDS

(71) Applicant: PYRO-E, LLC, SAN JOSE, CA (US)

(72) Inventors: David G. Gerhart, East Windsor, NJ (US); Murat Piker, Freehold, NJ (US)

(73) Assignee: PYRO-E, LLC, SAN JOSE, CA (US)

(21) Appl. No.: 14/147,359

(22) Filed: Jan. 3, 2014

Related U.S. Application Data
(60) Provisional application No. 61/748,760, filed on Jan. 4, 2013.

(51) Int. Cl. H02N 11/00

(52) U.S. Cl. CPC H02N 11/002
USPC 310/306

(57) ABSTRACT

The invention provides apparatus and methods for heating and cooling ferroelectric materials during a conversion between thermal and electrical energy. One method comprises the use of a fluid that performs repeated heating and cooling cycles, e.g., ‘thermal cycling’, of ferroelectric materials during the evaporation and condensation of a phase changing fluid. The systems, devices, and methods eliminate the need for external inputs such electrical or mechanical power, thereby improving the overall efficiency of the energy conversion. One apparatus comprises liquid-retaining wicks that helps fluid distribution and expands the range of operational environment for the energy system. Ultimately, the uniformity and speed of various embodiments of the thermal cycler apparatus and method provide improvements in conversion efficiency and reductions in parasitic loss over current thermal cyclers.

The present application claims priority to U.S. Provisional Patent Application Ser. No. 61/748,760, filed Jan. 4, 2013, the disclosure of which is herein incorporated by reference in its entirety.

### FIELD

The present invention generally relates to conversion of heat to electrical energy, and more particularly to methods that utilize the spontaneous polarization of ferroelectric materials. Heat is converted into electrical energy power when the materials are cycled within a temperature range corresponding to their ferroelectric-paraelectric phase. The present invention specifically pertains to the thermal cycling of ferroelectric materials using phase-changing fluids without external input or power. The disclosed apparatus and method allow for rapid, uniform and accurate exchange, e.g. addition and removal, of heat to the aforementioned materials. A broad base of end-users can benefit from a viable technology that converts heat energy into electricity, including applications for automobiles, diesel generators, and aircrafts. Furthermore, the technology can provide benefit to society in the form of cheaper energy, less reliance on fossil fuel, and improved environmental quality.

### BACKGROUND

The use of capacitors with temperature dependent dielectric constant to convert heat into electric energy is known. Representative devices that use dielectrics as variable capacitors to generate electricity are disclosed by, for example, Drummond (U.S. Pat. No. 4,220,906), Olsen (U.S. Pat. Nos. 4,425,540 and 4,647,836), Ikura et al. (U.S. Pat. No. 6,528,898), and Kouchachvili et al. (U.S. Pat. No. 7,323,506). Those devices utilize the fact that the dielectric constant of certain materials, such as ferroelectrics, varies with temperature. Specifically, those devices use the dielectrics as temperature dependent variable capacitors, the capacitance of which decreases as the temperature is increased by the absorption of heat. The capacitor is partially charged under an applied field at the lower temperature, and is then fully charged by increasing the electric field. The capacitor is then heated while under the electric field, and it partially discharges as the dielectric constant decreases with increasing temperature and correspondingly decreasing capacitance. Further discharge occurs by reducing the applied field while the capacitor remains at high temperature (Olsen, U.S. Pat. No. 4,425,540). Such cycling of the temperature and dielectric constant of a capacitor under an applied field is referred to as the Olsen cycle.

Another method proposed by Erbil et al. (U.S. Pat. Nos. 8,035,274; 7,982,360) accomplishes the conversion of heat into electricity uses a similar type of temperature-sensitive capacitor material. The disclosed invention provides apparatuses and methods for converting heat to electric energy by switching one or more ferroelectrics in and out of the critical ferroelectric phase. The invention particularly utilizes the spontaneous polarization, together with the rapid change in that polarization that occurs during phase transition, to convert heat to electrical energy. The disclosed invention does not require temperature variability of the dielectric constant of the ferroelectric material.

The prior art in the field of ferroelectric energy conversion have major shortcomings that prevent the adoption of one or more aspects of the technology. In particular, pumped hot and cold fluids have been described as a means to cycle the temperature of ferroelectric materials. Within these methods, single or two-phase refrigerants were considered for thermal cycling. However, these conventional methods have several intrinsic limitations. For example, Olsen (U.S. Pat. Nos. 270,105 and 4,425,540) describes a thermal cycler that pumps single-phase oils through a stack for ferroelectric materials. Similarly, Erbil (U.S. patent Ser. No. 13/288,791) describes a thermal cycler that deploys two-phase heat transfer for heating and cooling. In limitations, both type of thermal cycling require external energy input as a means to conduct the necessary thermal cycling of ferroelectric materials. In various embodiments, a device intended for heat to electricity conversion can be driven solely from the thermal source as a method to reduce parasitic loss.

The present invention provides an alternative method of thermal cycling using a phase-changing fluid without external input. The disclosed apparatus and method deploys a concept that allows passive fluid pumping as a means of increasing overall system efficiency, reducing weight, and simplifying design. The self-sufficient, rapid heating and cooling concepts differentiate from other two-phase heat transfer methods by powering the thermal cycles and thermal conversion with energy extracted from a single heat source. The procedure does not require external power input and thereby operates passively between a thermal source and thermal sink, maximizing overall conversion efficiency. Other differentiating factors include concepts that allow a broader range of operating conditions such as zero-gravity and high acceleration environments.

### SUMMARY

The present invention provides an apparatus and method for converting heat to electric energy by the use of ferroelectric materials that exhibits the ferroelectric-paraelectric (F-P) phase transition. Energy is converted using ferroelectrics in which the F-P transitions changes the dielectric properties of the material at any desired temperatures. Specifically, this invention discloses an enhanced thermal cycling apparatus and method that operates passively without external power. In particular, thermal cycling is conducted in a manner that it only requires energy extracted from a single thermal source. The operation does not require external electrical inputs for fluid pumping or return as a part of the thermal circuit responsible for heating and cooling the ferroelectric materials. One advantage of various embodiments allows for greater electrical energy output and higher system efficiency than may be possible with other cycles.

When in the ferroelectric phase, a material whose unit cells may spontaneously develop very strongly polarized electric dipoles with or without the application of an external field. By poling to align the unit cells and domains, the polarization of the individual unit cells and domains combines to produce an extremely large net spontaneous polarization in the overall material system. That net polarization may also be referred to as the remnant polarization in the absence of an external field. The present invention utilizes the spontaneous polarization, together with the rapid change in that polarization that occurs during thermal cycling and phase transition, to convert heat to electrical energy. The present invention may or may not require temperature variability of the dielectric constant of the ferroelectric material.

The present invention is a thermal cycler apparatus that provides rapid heating and cooling methods for use with the ferroelectric conversion method and apparatus. The manner of thermal cycling according to one or more aspects can provide significantly improvements in speeds, uniformity, accuracy, and thermal efficiency than prior arts. The thermodynamic cycling method alters the pressure of a working refrigerant fluid such as water, fluorinated fluids, or R134. In certain embodiment, the thermal cycler device comprises a first, second, and a third pressure or vacuum vessels. A phase changing fluid is provided and shuttled between the three vessels. The first vessel holds high-pressure vapor or vapor-liquid mixture at high temperatures. The second vessel holds low-pressure vapor, or vapor-liquid mixture, at low temperatures. The third vessel holds the aforementioned ferroelectric material as well as a working fluid that varies in temperature and pressure. The properties of fluid in third vessel vary in between those associated with the first and second vessel.

The first and second vessels hold a fluid content that is ideally kept at constant condition in pressure and temperature during operation. The pressure difference is maintained between the first and second vessel with a passive jet pump. The jet pump works in a manner that closely resembles that of a Venturi nozzle with an added diffuser section. The pump interconnects the first and second vessel. Providing first and second valves, the first valve interconnects the first and third vessel. Second valve interconnects the second to third vessel. The third reactant chamber, which also holds the ferroelectric materials, receives the fluid vapor or vapor-liquid mixture from the first vessel during heating. This process yields fluid condensation at the surfaces of ferroelectric materials to produce effects of heating. During cooling, the third vessel vents the inner fluid into the second vessel. This process yields fluid evaporation at the surfaces of ferroelectric materials to produce effects of cooling. The shuttling of vapor or vapor-liquid mixture is controlled via the first and second valves, which may be mechanical or electrical one-way or two-way valves. To return fluid from the second to first vessel, the jet pump combines fluids from first and second vessel inside a diffuser nozzle to generate the pressure different needed to replenish the first vessel fluid with the second vessel fluid.

In summary, the novelty of the proposed thermal cycling apparatus and method for ferroelectric energy conversion includes:
Permitting high heat transfer rates of boiling and condensation to achieve high thermal cycling rates, uniformity, and accuracy of ferroelectric materials.
Permitting self-drive, passive operation without external input. Fluid pumping is driven by the same heat source as the one supplying the energy for electricity generation.
Permitting zero-g or high-g operation by using liquid wick for fluid distribution inside fluid vessels.
Employing near-reversible energy conversion cycles for improving system efficiency.

Thus several advantages of one or more aspects are to provide a smaller, faster thermal cyclers that can provide thermal cycling to a substantial mass of ferroelectric materials in parallel. These and other advantages of one or more aspects will become apparent from a consideration of the ensuing description and accompanying drawings.

### BRIEF DESCRIPTION OF THE DRAWINGS

The accompanying drawings illustrate one or more embodiments of the disclosed method and apparatus used in generating electricity from heat. The embodiments will now be described with reference to the accompanying drawings, in which:

FIGS. 1A and 1B are schematics depicting the ferroelectric generator in accordance with an embodiment of the invention.

FIG. 2 is a schematic depicting the thermal circuit in accordance with an embodiment of the invention.

FIGS. 3A and 3B are schematics depicting the sectional view for various components in accordance with an embodiment of the invention.

FIG. 4 is a plot showing the temperature vs. time data for a thermal cycling prototype in accordance with an embodiment of the invention.

### DETAILED DESCRIPTION

Henceforth, the terminology ‘fluid’ is used interchangeably with saturated or superheated vapor, saturated or undercooled/supercooled liquid, or a mixture of vapor and liquid. The fluid may comprise a first and a second fluid component of different molecular composition. The first and second fluid components may exist in the same or different phases, e.g. solid, liquid or gas/vapor. In the liquid phase, the first and second fluid components may be miscible or immiscible. When in gas phase, the first and second component will mix uniformly through intermolecular diffusion. The first and second fluid components may also exist as a two-phase mixture at different ‘quality’ ratios, as measured by the mass or mole fraction of the first fluid component of the whole mixture. Multi-component fluids may comprise 3 or more molecular species.

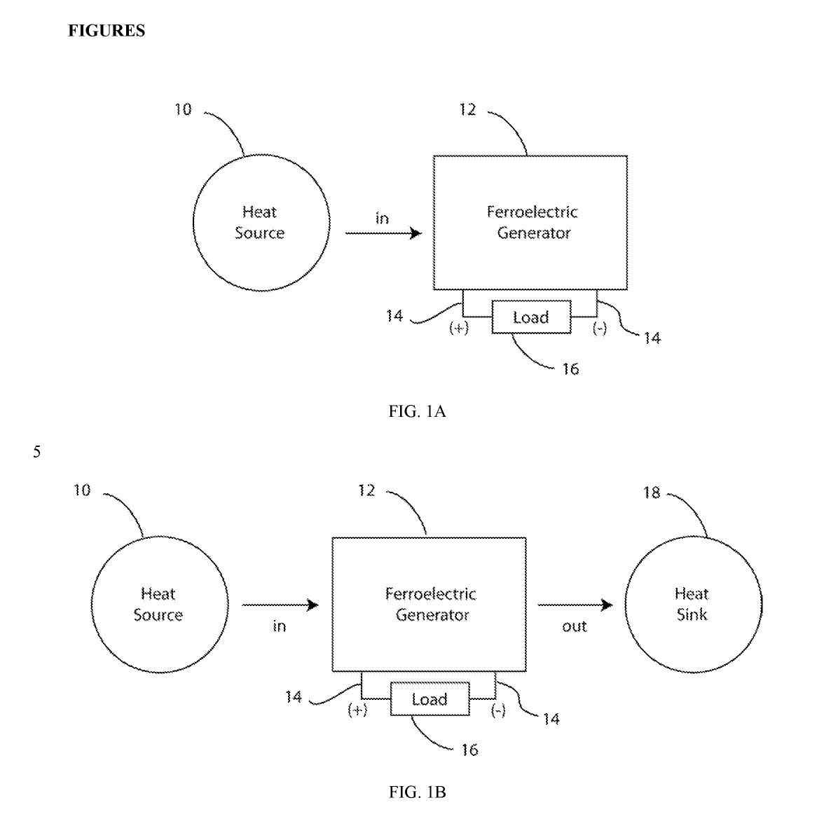

### FIG. 1

FIG. 1 depicts the components in part of the method and apparatus of ferroelectric energy conversion used for converting various forms of energy into electrical energy. Referring to FIG. 1A, a heat source 10 provides the thermal energy needed for energy conversion processes to product electricity. The heat source 10 is placed in thermal contact with a ferroelectric generator 12. The said generator comprises ferroelectric material that may or may not be polarized with surface charge, a characteristic property of the said material that may be used to create electric energy. To one skilled in the art, the ferroelectric material may be described to hold remnant polarization. A power terminal 14 supplies electrical current to a resistive or an inductive load 16. Now referring to FIG. 1B, a thermal sink 16 is placed in thermal contact with the ferroelectric generator 12. To one skilled in the art, a thermal contact may represent both physical and non-physical contact as long as heat is transferred between two bodies. Heat may be transferred through independent or a combined means of conduction, convection and radiation. In various embodiments, the heat source 10 and heat sink 18 may exchange heat with the ferroelectric generator 12 through conduction by physical contact. In various embodiments, the heat source 10 and heat sink 18 exchanges heat with generator 12 through convection using a working fluid that circulates between the said source, sink and generator. In various embodiments, the heat source 10 and heat sink 18 exchanges heat with generator 12 through radiation in a vacuum such as extraterrestrial space.

Now referring to FIG. 1A, the procedure of single-use energy conversion is described as follows. Initially, the heat is transferred from the heat source 10 to the ferroelectric generator 12. The heat transfer process may be controlled using a thermal switch or a throttle valve. In various embodiments, the thermal switch is used to separate the physical contact between the heat source 10 and the ferroelectric generator 12 as a means to control heat transfer between said components. In various embodiments, the throttle valve is used modulate the flow of a convective fluid as a means to control heat transfer between heat source 10 and ferroelectric generator. Subsequently, once heat is transferred to the generator 12, electricity is generated for powering a resistive or inductive load device 16. In various embodiments, the procedure described herein provides a means of generating power in a single-use. The heat source 10 may be created through chemical, kinetic or combustion processes. In various aspects, the said process may occur substantially fast in a span between 1-100 microseconds.

Now referring to FIG. 1B, the procedure of continuous energy conversion is described as follows. Initially, the heat is transferred from the heat source 10 to the ferroelectric generator 12. After a slight delay, typically between 0.1 and 1 second, heat is transferred from the said generator 12 to the heat sink. The heat transfer processes may be controlled using a thermal switch for conduction or a throttle valve for convection. In various embodiments, the thermal switch is used to separate the physical contact between the heat source 10 and the ferroelectric generator 12 as a means to control heat transfer between said components. In various embodiments, the throttle valve is used modulate the flow of a convective fluid as a means to control heat transfer between heat source 10 and ferroelectric generator. Subsequently, once heat is transferred to the generator 12, electricity is generated for powering a resistive or inductive load device 16. The procedure described herein provides a means of generating power intermittently or continuously. The heat source may be created through chemical, kinetic or combustion processes. In various embodiments, the convective fluid may circulate from the heat sink 18 back to the heat source 10 to repeat the cyclic process.

Referring to FIGS. 1A and 1B, the output by the generator 12 may provide substantial electric field, voltage, or power to the load 16. In various aspects, the electric field produced may be in the range 10⁶ to 10⁸ V/cm, the voltage in the range of 100 V to 1000 kV and power in the range of 1 W to 1 MW. These various output parameters and values that match the load 16 requirements. The heat source may have a nominal, e.g. typical operating condition, power range between 10 kW to 10 MW. The heat source may comprise energy contained in chemical, hydrodynamic, or mechanical energy storage systems such as lithium/acid batteries, pressure vessels, flywheels, or other small and large-scale grid storage systems. The heat source may comprise energy emitted by industrial processes such as the waste energy released by smelting, forming, extruding, and other means that occur during of metal, plastic, ceramic, paper, and cement manufacturing. The heat source may comprise energy released by explosive or high-impact device that are used by civilian and military power platforms. The heat source may comprise energy contained, emitted or release by thermal-related systems not limited to the ones described.

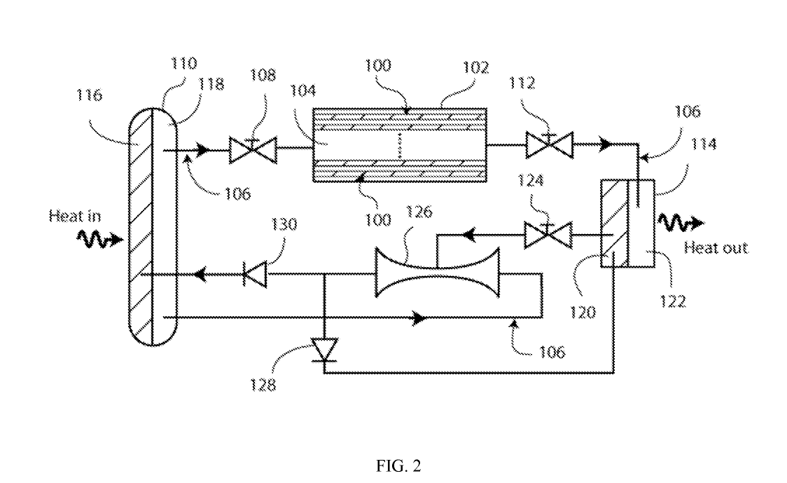

### FIG. 2

FIG. 2 depicts the components in part of the method and apparatus of ferroelectric energy conversion. The energy conversion system comprises one or more embodiments include a plurality of ferroelectric plates, sheets or films 100. Films 100 may also be commonly referred by those skilled in the art as pyroelectric materials. Films 100 are enclosed inside one or more tank, chamber or vessel 102. Inside vessel 102, a working fluid 104, in direct contact with films 100, fills the interstitial void or spacing inside vessel 102. Vessel 102 comprises multiple openings. At one opening, vessel 102 is connected to a fluid tubing or conduit 106 that leads to a hot valve 108. Valve 108 is also connected to a conduit that leads to a hot evaporator or heat exchanger 110. Similarly, vessel 102 is connected to another conduit 106 that leads to a cold valve 112. Valve 112 is also connected to a cold condenser or heat exchanger 114. Inside heat exchanger 110, an open structure, foam or wick 116 forms one part or section of hot exchanger 110, whereas the other section holds a hot fluid 118. Inside heat exchanger 114, an open structure, foam or wick 120 forms one part or section of heat exchanger 114, whereas the other section holds a cold fluid 122. Connecting to heat exchanger 114 is a mechanical or jet pump 126, which has a total of 3 or more openings. A second opening of pump 126 is connected to wick 116 inside hot exchanger 110. A third opening of pump 126 is connected to hot vapor 118. Also, a fluid valve 128 is connected between pump 126 and heat exchanger 114. Another fluid valve 130 is connected between pump 126 and hot exchanger 110.

In more detail, vessel 102 is insulated for heat retention to prevent heat transfer to and from the surrounding. Vessel 102 is sealed against liquid or vapor leak to maintain pressure or vacuum of working fluid 104. Together, thermal insulation and pressurized seal of vessel 102 provide a means of maintaining the temperature and pressure of fluid 104. Hot exchanger 110 provides a means of maintaining a predetermined temperature and pressure of fluid 118, and also receiving heat or thermal energy from the surrounding. Similarly, cold heat exchanger 114 provides a means of maintaining a predetermined temperature and pressure of fluid 122, and also rejecting heat or thermal energy to the surrounding. Wicks 116,120 retains the liquid content of fluids 118, 122 and this provides a means of distributing evenly, countering the effect of gravity, and improving heat transfer characteristics of the fluids inside vessel 102 and heat exchangers 110, 114. Jet pump 126 provides a means of maintaining a predetermined pressure and temperature difference between the hot and cold fluids 118,122. Conduits 106 provide a means of transporting fluids 104, 118, 112 between vessel 102 and heat exchangers 110, 114. Fluid valves 108, 112, 124, 128, 130 provide a means of controlling, modulating or stopping the flow of fluids 104, 118, 122. In further detail, referring to FIG. 2, the thermodynamic properties of fluids 104, 118, 122, are summarized as follows. Hot fluid 118 is maintained at substantially high pressures and temperatures, as a means of receiving heat or thermal energy from the surrounding. Cold fluid 122 is maintained at substantially low pressures and temperatures, as a means of rejecting heat or thermal energy to the surrounding. Working fluid 104 is maintained at temperatures and pressures in between those of fluids 118 and 122, as a means of transferring heat or thermal energy to and from the ferroelectric films 100. In various aspects, all three fluids 104, 118, 122 are the same substance in this embodiment.

In further detail, fluids 104, 118, 122 are single or multi-component substance that has a number of predetermined thermodynamic states that correspond to either vapor, liquid or the solid phase. To those skilled in the art, these states are definable by temperature, pressure and density. At phase transition, temperature and pressure together defines the saturation states for a fluid confined in a rigid vessel. In one or more embodiments, fluids 104, 118, 122 have properties that are at or near the aforementioned saturation states. Given these conditions, the temperature and pressure of fluids 104,118, 122 would not vary independently. As a result, maintaining fluids 104, 118, 122 at or near saturation inside their respective vessels provide the means of controlling the temperature of said fluids by changing the corresponding pressure. As a result, the pressure-drive temperature change of fluid 104 provides a means of exchanging thermal energy, e.g., heating and cooling, with the ferroelectric films 100.

In further detail, still referring of FIG. 2, the hardware specifications described below should satisfy the design of one or more embodiments. The reactant chamber 102 is sufficiently wide (W), long (L) and tall (H) to secure and seal the ferroelectric films 100 in place. Chamber 102 may have outer dimensions 5″ by 6″ by 1″ (Width×Length×Height) to hold a substantial mass quantity of films 100. The size of the hot exchanger 110 is sufficiently wide, long and tall so that the temperature and pressure of the conditions inside the chambers does not vary significantly (e.g., 5 percent or less) during operation. Heat exchangers 110,114 may have outer dimensions measure 6″ by 6″ by 5″ (W×L×H). The walls of vessel 102 and heat exchangers 110 and 114 may also provide thermal insulation to reduce parasitic thermal loss. Valves 108 and 112 are sufficiently large, measured in terms of maximum pressure rating and flow coefficient, to allow rapid venting of the vapor between vessel 102 heat exchangers 110 and 114 and pump 126. Flow rate may be measured in units of cubic feet or ounces per second. The proper valves to use typically balance the trade-off between input powers, flow rate and speed.

Still referring to FIG. 2, the construction material of vessel 102 and heat exchangers 110,114 should be substantially rigid and strong to withstand or maintain their shape against positive and negative pressure difference, e.g., gauge pressure, measured against atmosphere. A few of the many possible materials are stainless steel, plastics, plastic composites, or other materials that has a Young's modulus greater than ˜50 GPa. The said materials should also protect against weathering, corrosion or scaling to maximize device life, in ways as understood by those skilled in the art. These protections may be attained with using compatible material or applying passivation coatings. The walls of chamber 102 and heat exchangers 110,114 may have a double wall, as a means to provide vacuum or a insulting materials with low thermal conductance inside the walls. The walls may also be evacuated to form vacuum inside said walls as a means for heat retention or insulation. The chosen construction methods and component dimensions should maximize thermal insulation against heat loss to the surrounding while minimizing built cost.

In further detail, conduits 106 may be constructed using various plastics or metals, including fluoroelastomer, silicone, PTFE, brass or steel that can withstand the temperature range of fluids 104,118,122. The outer diameter of said tubing may be between ½″ to 3″. In various aspects, line or tubing 612 may be braided with metal sheathing to maintain pressure and prevent contraction or expansion of said line or tubing. Optionally, conduits 106 are thermally insulated for heat retention. Also, any connections made with conduits 106 are either compression-fitted, threaded or welded to prevent vapor or liquid leakage at large pressures.

In further detail, valves 108, 112, 124 can be a pneumatic, a solenoid, or any other desired valve types. Valves 108, 112, 124 can be attached to other components either with threaded or welded connections, as a means to prevent fluid leakage under positive or negative gauge pressures up to ˜250 psi gauge pressure. Valves 108, 112, 124 should also be able to quickly open and close with substantially precise timing as to allow a predetermined amount of vapor to pass through (e.g. 1-10 Hz with 10% accuracy). The duration of the opening for valves 108, 112, 124 is typically 0.001-0.1 second to allow precise heating and cooling control. Valves 128, 130 are a passive type that does not require external power input. Valves 128, 130 opens and closes depending on the inlet and outlet pressure difference, as a means to allow fluid flow in only one direction and not the other. Furthermore, the seals of valves 108,112,124,128,130 should use a material able to withstand the highest temperature reached by the hot heat exchanger 110 (e.g., stable up to 350° C. such as fluoroelastomer, silicone, PTFE or other compounds). The valve seals should also be chemically compatible, e.g. no degradation over time, to the chosen working fluid. In various aspects, valves 108,112,124,128,130 may be actively or passively controlled in ways understood by those skilled in the art, as means of simplifying the thermal circuit with a less substantial number of external inputs.

In further detail, the inner wall of vessel 102 and heat exchangers 110,114 may comprise of a wick made up of an opened structured foam, wire or screen. The function of wicks 116,120 is to provide a structure that retains and distributes the condensed liquid of fluids 118,122. The extended surface area of wicks 116,120 also provides a means of promoting nucleation sites for the condensation or evaporation processes during heating and cooling, respectively. Another advantage is to improve the temperature uniformity within the confining vessels. Also, wicks 116,120 provide the means of preventing dry-out conditions during heating and cooling. Dry-out occurs during evaporation when a particular surface area becomes dry and can no longer create the associated heat transfer effect. In various embodiments, a separate holding tank (not shown) may contain working fluid liquid that is placed inside or outside vessel 102 and heat exchangers 110,114.

Still referring to FIG. 2, the schematic describes one embodiment of the thermal cycling method and apparatus. Specifically, the procedure of cooling the working fluid 104 as a means of cooling films 100 is described as follows. Initially, subsequent to the heating procedure, fluid 104 is above the F-P transition set by the Curie temperature of films 100. Valve 108 is now closed. Subsequently, fluid 104 is cooled to a temperature below the Curie temperature by opening and closing valve 112 for a predetermined period of time. A typical opening time is 0.1-5 seconds. The above results in a substantial quantity of working fluid 104 vented into heat exchanger 114. This occurs because vessel 104 maintains a predetermined vacuum, e.g., negative gauge pressure, lower than heat exchanger 114 by pump 126 and by fluid condensation. Subsequently, some fluid 104 will evaporate and escape vessel 102 and causes its pressure and, therefore, temperature to fall below the Curie temperature. Finally, the ferroelectric films 100 transfer heat to the remaining fluid 104 inside vessel 102 and thereby become cooled. The desired amount of cooling, as predetermined by the temperature change of film 100, is controlled by the opening duration of valve 112. In one or more aspects, valve 112 is controlled electronically and can open and close with frequencies up to 1000 cycles per second. The high rate of actuation can, in some aspects, allow precise control of the vapor flow vented into heat exchanger 114.

Referring to FIG. 2, the procedure of heating the working fluid 104 as a means of heating films 100 is described as follows. Initially, subsequent to the cooling procedure, fluid 104 is below the F-P transition set by the Curie temperature of film 100. Valve 112 is now closed. Subsequently, fluid 104 is heated to a temperature above the Curie temperature by opening and closing valve 108 for a substantial period of time. A typical opening time is 0.1-5 seconds. The above results in a substantial quantity of hot fluid 118 vented into vessel 102. This occurs because hot heat exchanger 110 maintains a predetermine pressure higher than vessel 102 by pump 126 and by fluid evaporation. Subsequently, fluid 118 entering vessel 102 will condense and raise the pressure of fluid 104, thereby heating said fluid above the Curie temperature. Finally, the ferroelectric films 100 receive heat from fluid 104 and thereby become heated. The desired amount of heating, as predetermined by the temperature change of films 100, is controlled by the opening duration of valve 108. In one or more aspects, valve 108 is controlled electronically and can open and close with frequencies up to 1000 cycles per second. High rates of actuation can, in some aspects, provide the means to better control the vapor flow vented into chamber 102.

Referring to FIG. 2, the manner of passive fluid return for which cold fluid 122 inside heat exchanger 114 is pumped into the hot heat exchanger 110 is described as follows. Initially, the wick is saturated with liquids that had condensed inside heat exchanger 114. Also, heat exchanger 110 is heated and pressurized to predetermined values. To start fluid return, valve 124 opens and hot fluid 118 enters the jet pump 126. When passing through a nozzle (not shown) inside pump 126, the accelerating hot fluid 118 creates a vacuum that draws in the liquids retained by wick 120. Then, mixing ensues inside pump 126 between the hot and cold fluid 118,122 as a means of creating a mixed fluid phase. The mixed fluid then travels through a diffuser (not shown) inside pump 126. A diffuser has a flow cross-section, whose area becomes progressively larger in the direction of flow. When passing through, the mixed fluid decelerates and exchanges the kinetic energy for potential energy. This exchange of energies provides a means of raising the mixed fluid pressure above that inside heat exchanger 110. Consequently, replenishing hot fluid 118 with cold fluid 122 in a manner described above provides a means of fluid return without needing external input or electrical power.

Still referring to FIG. 2, the procedure for the conversion of heat into electricity is given as follows. Hot heat exchanger 110 is placed near or in contact with a high temperature source as a means of extracting thermal energy. Subsequently, some liquid content retained by wick 118 evaporates and raises the temperature and pressure of fluid 118. This maintains fluid 118 above the Curie temperature. At this time, an electric poling field is applied across the opposite sides of the ferroelectric films 100 as a means of generating oppositely charged film surfaces. Once fluid 118 reaches a predetermined temperature, the manner for which the charged ferroelectric films 100 is heated follows the heating procedure as described previously. Once heated, films 100 disconnects from the poling field and connected to an external resister load such as a battery. The high voltage charges then flow from films 100 into the external resister (not shown in FIG. 2) as a means to generate usable electricity. In various aspects, films 100 become fully discharge after discharging. Then, the aforementioned cooling procedure ensues as films 100 are cooled below the Curie temperature. Subsequently, as the working fluid vents into heat exchanger 114, some condenses and this increases the temperature and pressure of fluid 122. The addition of thermal energy is rejected into the surrounding so that fluid 122 can maintain below the Curie temperature. Now to complete the thermal circuit as shown in FIG. 2, fluid 122 returns to heat exchanger 110 in a manner described previously. To convert heat continuously into electricity, the above procedure can be repeated in cycles. In various embodiments, pressure and temperature are tracked and valves 108,112,124 regulated by sensors and external electronics to maintain continuing operation of the procedure described herein.

In various aspects, a low poling field is maintained on films 100 after discharging as a means to maintain partial polarization of the polymer molecules. The orientation of films 100 may be arranged in stacks and separated by non-conductive spacers. The orientation may comprise films in parallel or in spiral layers as a means of densely packing the material inside vessel 102. The spacing between adjacent films must be wide enough to allow substantial fluid transport during cycles of heating and cooling.

In various aspects, the procedure for ferroelectric energy conversion as described requires priming before normal operating procedure as described earlier. Specifically, jet pump 126 may require a brief startup to build up pressure at the diffuser exit. In various aspects, valve 128 is vented to atmosphere or to another holding vessel (not shown) for storage. Another aspect that require priming is the waiting time associated with reaching the predetermine temperatures and pressures for fluids 118, 122. Fluid 118 require reach above the Curie temperature where as fluid 122 below the Curie temperature. The latter fluid 122, also, much reach substantial temperatures so that heat may be rejected from heat exchanger 114 as required during ferroelectric conversion.

In various embodiments, hot and cold heat exchangers 110, 114 may take the form of a heat exchanger with an external surface. Hot heat exchanger 110 may be specifically called a boiler or a evaporator, where as heat exchanger 114 a condenser. Here, fins, plates or other components that extend the surface area may be added in part to heat exchangers 110, 114 to provide means of effective heat transfer with the surrounding. To those skilled in the art, the effective of heat transfer is measured by the thermal resistance such as values represented in units of /W. In general, heat exchangers 110,114 may exchange heat with the surrounding environment through one or a combination of the three modes: conduction, convection, and radiation. For example, heat exchanger 110 may be placed in contact with a hotter surface, a hotter moving or static fluid, or near a hotter object in a vacuum environment such as space. Similarly, heat exchanger 114 may be placed in contact with a relatively colder surface, a colder moving or static fluid, or near a colder object in a vacuum environment such as space.

In further detail, wicks 118,120 retain liquid in a manner that provides uniform fluid distribution against acceleration forces such as gravity or propulsion in a moving system. The liquid retaining power, measured in the capillary pressure of the interstitial liquid, scales inversely proportional to the pore size of the wick and the surface tension of the liquid.

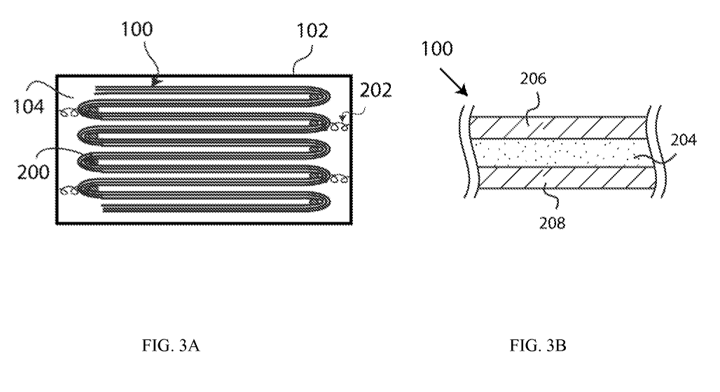

### FIG. 3

Referring to FIGS. 3A and 3B, the schematic depicts the components in part of the method and apparatus of ferroelectric energy conversion. Specifically, as shown in FIG. 3A, the energy conversion uses ferroelectric films 100 inside chamber 102. Between the films 100, rigid brackets or spacers 200 are uses in between said films. Spacers 200 have a thickness that is substantially thin as a means to minimize the overall thickness of films 100. Optionally, spacers 200 are connected to vessel 102 directly. In other aspects, spring 202 connects the spacers 200 to vessel 102 and applies a tension force on the films. Tension forces are applied in the direct of stretching films 100 as a means of maintaining a clearance or space for fluid flow during the heating and cooling procedure described in reference to FIG. 3. The spring tension force is substantially large so that films 100 do not collapse and make contact with neighing films during fluid transport. The tension force must be kept substantially small as to below material limitation or not impede the energy conversion mechanism as outlined herein.

Referring to FIG. 3B, the ferroelectric films 100 comprise three different materials arranged in top, base, and bottom layers. The middle layer comprises the ferroelectric layer 204 with properties that provide the means of converting heat into electricity. The middle layer has top and bottom surfaces. The top surface is placed in direct electrical contact with the top layer, which is an electrically conductive material or electrode 206. Similarly, the bottom layer is an electrically conductive material or electrode 208. Both top and bottom electrodes are placed in direct, electrical contact with the base layer.

In further detail, referring to FIGS. 3A and 3B, the top and bottom electrodes 206,208 provide a means of charging and discharging the capacitor that is the ferroelectric layer 204. Electrodes 206,208 may have varying thicknesses and patterns or they may comprise a single or a composite conductive material. These and other variations in the type of electrodes may provide a means of improving or enhancing charge transfer, thermal transfer, the compatibility of coupling with the ferroelectric layer 204 or the operational life of the entire film 100. In further detail, the top and bottom electrodes 206,208 cover the center area of the ferroelectric layer 204, away from the edges, as a means to avoid electrical contact or any chances of shorting under a predetermined electric field. Electrical shorting is an occurrence where, under large electric fields, electric charges or current travels through the interstitial, dielectric fluid space 104. The electric short bypasses the base ferroelectric layer 204 and discharges the buildup electric field. In various embodiments, partial electrode coverage and other related methods provide a means of eliminating electrical short around the edges of the base ferroelectric layer 204.

Referring to FIGS. 3A and 3B, the properties of the ferroelectric layer 204 are described in further detail. In various embodiments, the polarizable material chosen for layer 204 has temperature-dependent dielectric property in a manner that allows a material to exhibit a temperature adjustable capacitance. Also, the ferroelectric layer is polarizable under an electric field as a means of exhibiting inherent spontaneous polarization as a result of electrical displacement hysteresis. The material also comprises molecules that are polarizable under the application of electric field. Polarizable materials typically has large spontaneous polarization of ferroelectric materials that occurs when they are in a temperature range corresponding to their ferroelectric phase, and diminishes or disappears rapidly as the ferroelectric materials approach, or transition into, their paraelectric or antiferroelectric phase as the temperature changes, so as to convert heat to electric energy. In various embodiments, examples of the energy conversion material may be polymeric, ceramic or other forms of dielectrics as a means of having the ferroelectric properties described herein.

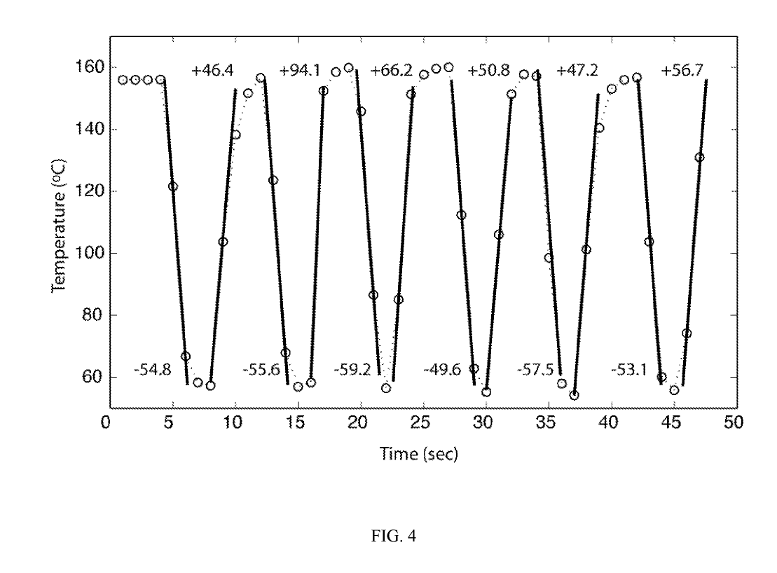

### FIG. 4

In reference to FIG. 4, the plot shows the temperature cycling data of the method and apparatus described herein. Temperature data in degrees Celsius ( ) is shown as a function time in seconds. The dotted-circle line is the measured data and the straight lines are fits to the data. The speed of cycling is measured by the average rates of heating and cooling. As demonstrated by the data, the average rates are 55/sec for heating and 54/sec for cooling. The method and apparatus described herein provide a means of obtaining fast, uniform and accurate cycles of heating and cooling. The speed of heating and cooling is measured by the change of temperature per unit time, e.g. +/−° C./s, on average for an object undergoing temperature change. Temperature uniformity is measured by the mean temperature difference between two or more objects undergoing temperature change, which may be quantified by +/−° C. deviation from the overall average temperature. Temperature accuracy refers the difference between the predetermined and the actual (measured) temperature of one or more objects undergoing temperature change. The accuracy may be measured as percent error from the target temperature. Temperature accuracy is particularly important for repeating the same hot and cold temperatures around the Curie point of the ferroelectric film 100.

In reference to FIG. 4, heating and cooling rate can range from 10 to 100° C./sec, uniformity from +/−0.01° C. and +/−1° C., and accuracy from +/−0.1° C. and +/−10° C. These values represent order-of-magnitude approximation of the various embodiments described herein.

In summary, the advantages of the embodiments include, without limitation, the use of phase-changing fluid to provide thermal cycling for ferroelectric energy conversion. From the description, a number of advantages of various embodiments of the thermal cycling method become evident and include, but are not limited to:
a. It permits rapid heating and cooling (>+/−40° C./s) given the substantially higher heat transfer rates that are associated with surface condensation and evaporation than other convective processes (e.g. in forced or shear flow).
b. It permits uniform heating and cooling (<0.1° C.) given that heat transfers at constant temperature between the plurality of samples. This is the physical property associated with the latent heat of vaporization and condensation.
c. It permits accurate temperature control (<5% within target temperature) given that the temperature and pressure is quickly and uniformly adjusted with a combination of fast-acting valves and heaters.
d. It permits either single or continuous energy conversion from heat into electricity, whose overall footprint size and weight is substantially smaller and lighter than existing power supply devices.
e. It permits passive operation in a manner that does not require electrical input for fluid return. The use of a jet pump allows higher system-level thermal efficiency, lighter weight, and simpler design than previously disclosed art.
f. It differentiates from other systems by which thermal cycling is conducted using forced air or liquid flows. The advantage is that pressure can be modified quicker and more uniformly than prior heating and cooling methods of using forced convection and conduction.
g. It permits operations in zero of micro-gravity environments such as outer space. The liquid-retaining wick also permits operations in fast accelerating bodies such as missiles and aircrafts.
h. Furthermore, the present embodiments can operate in a closed cycle, where it recovers the energy used in thermal cycling to permit more efficient operation than other convection or conduction methods where energy is dissipated or wasted to the surrounding.

Accordingly, given that the disclosed ferroelectric conversion apparatus and methods, provide the means of directly and efficiently converting heat into electricity. The advantages of various embodiments include lightweight, silent operation, little or no moving parts, and via a thermodynamic cycle that is capable of substantial efficiency. Other possible configuration of the embodiment include many copies of the system connected in parallel, e.g. forming a daisy-chain, as a means to reduce cost, improve energy yield and conversion efficiency.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A method for generating electrical current, comprising: heating a ferroelectric material above the Curie temperature of said ferroelectric material; wherein said heating uses no electrical energy.

2. The method of claim 1, where in the electrical current generation is executed for a single use.

3. The method of claim 1, comprising: heating and cooling a ferroelectric material via thermocycling, wherein said ferroelectric material is in contact with a fluid, wherein said thermocycling comprises raising and lowering the temperature of said fluid above and below the Curie temperature of said ferroelectric material; wherein said raising and lowering is conducted with a fluid circulation component that uses no electrical energy.

4. The method of claim 3, wherein the fluid circulation component permits heating and cooling at the rate of at least +/−50° C./s.

5. The method of claim 3, wherein the heating and cooling of the ferroelectric material is executed uniformly such that the temperature differential between any two regions of the ferroelectric material is at most 0.1° C.

6. The method of claim 3, wherein the heating and cooling of the ferroelectric material is accurate within 5% of a target temperature.

7. The method of claim 3, wherein the fluid circulation system uses exclusively passive fluid dynamics.

8. The method of claim 3, wherein the method is performed in zero- or micro-gravity environments or in accelerating or decelerating bodies.

9. The method of claim 3, wherein the fluid circulation component is entirely powered by thermal energy.

10. The method of claim 3, wherein the fluid circulation component functions regardless of directional orientation and acceleration or deceleration of the fluid circulation component.

11. The method of claim 3, wherein the fluid circulation component uses a wick.

12. A method for generating electrical current, comprising: heating and cooling a ferroelectric material via thermocycling, wherein said ferroelectric material is in contact with a fluid, wherein said thermocycling comprises raising and lowering the temperature of said fluid above and below the Curie temperature of said ferroelectric material; wherein said raising and lowering is conducted with a fluid circulation component comprising a wick.

13. The method of claim 12, wherein the wick is open structured foam, wire, or screen.

14. The method of claim 12, wherein the heating and cooling of the ferroelectric material is executed uniformly such that the temperature differential between any two regions of the ferroelectric material is at most 0.1° C.

15. The method of claim 12, wherein the fluid circulation system uses exclusively passive fluid dynamics.

16. An electrical generator comprising:
a. a ferroelectric material;
b. a fluid chamber in contact with said ferroelectric material;
c. a fluid circulation component for movement of fluid to and from the fluid chamber; and
d. a control system for thermocycling heated and cooled fluid to said fluid chamber using said fluid circulation component to heat and cool said ferroelectric material above and below its Curie temperature;
wherein said fluid circulation component is not powered by electrical energy.

17. The electrical generator of claim 16, wherein the fluid circulation component uses exclusively passive fluid dynamics.

18. The electrical generator of claim 16, wherein the fluid circulation component is entirely powered by thermal energy.

19. An electrical generator comprising:
a. a ferroelectric material;
b. a fluid chamber in contact with said ferroelectric material;
c. a fluid circulation component for movement of fluid to and from the fluid chamber; and
d. a control system for thermocycling heated and cooled fluid to said fluid chamber using said fluid circulation component to heat and cool said ferroelectric material above and below its Curie temperature;
wherein said a fluid circulation component comprising a wick.

20. The electrical generator of claim 19, wherein the wick is open structured foam, wire, or screen.
